(19) United States
(12) Patent Application Publication
(10) Pub. No.: US 2010/0250132 A1
(43) Pub. Date: Sep. 30, 2010

(54) OPTIMAL CODING OF GPS MEASUREMENTS FOR PRECISE RELATIVE POSITIONING

(75) Inventor: Shuqing Zeng, Sterling Heights, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/412,688

(22) Filed: Mar. 27, 2009

(51) Int. Cl. G01C 21/00

(52) U.S. Cl. 701/214

(57) ABSTRACT

A system for coding GPS measurements in a vehicle satellite communications system. The system includes a stand-alone position and velocity estimator that generates an estimated latent state vector from GPS measurements received at a first time and a prediction of a latent state vector from a previous time. The system also includes an observation prediction model that calculates an observation prediction from the estimated latent state vector. The system further includes a first differencer that provides a difference between the observation prediction and the GPS measurements, and a first Huffman encoder that provides a coded output from the difference. The system also includes a state prediction model that provides the predicted latent state vector and a second differencer that provides a difference between the estimated latent state vector and the predicted latent state vector. A second Huffman encoder encodes the difference from the second differencer.

### BACKGROUND OF THE INVENTION

1. Field of the Invention

This invention relates generally to a system and method for coding GPS measurements and, more particularly, to a system and method for coding GPS measurements for precise relative positioning in a vehicle communications system, where the system employs a Huffman encoder.

2. Discussion of the Related Art

Short-baseline precise relative positioning of multiple vehicles has numerous civilian applications. By using relative GPS signals in real-time, a vehicle can establish a sub-decimeter level accuracy of relative positions and velocities of surrounding vehicles (vehicle-to-vehicle object map) that are equipped with a GPS receiver and a data communication channel, such as a dedicated short range communications (DSRC) channel. This cooperative safety system can provide position and velocity information in the same way as a radar system.

For precise relative positioning, a vehicle needs to broadcast its raw GPS data, such as code range, carrier phase and Doppler measurements. The bandwidth required to do this will be an issue in a crowded traffic scenario where a large number of vehicles are involved.

Data format defined in The Radio Technical Commission for Maritime Service Special Committee 104 (RTCM SC104) contains unwanted redundancy. For example, message type #1 (L1C/A code phase correction) uniformly quantizes corrections with a 0.02 meter resolution. The pseudo-range measurements are thus represented in a range of ±0.2×2¹⁵ meters. However, the pseudo-range measurements are generally limited to about ±15 meters. It is thus noted that excess bandwidth wastage occurs if the RTCM protocol is directly used in a cooperative safety system.

### SUMMARY OF THE INVENTION

In accordance with the teachings of the present invention, a system and method are disclosed for coding GPS measurements in a vehicle satellite communications system. The system includes a stand-alone position and velocity estimator that generates an estimated latent state vector from GPS measurements received at a first time and a prediction of a latent state vector from a previous time. The system also includes an observation prediction model that calculates an observation prediction from the estimated latent state vector. The system further includes a first differencer that provides a difference between the observation prediction and the GPS measurements, and a first Huffman encoder that provides a coded output from the difference. The system also includes a state prediction model that provides the predicted latent state vector and a second differencer that provides a difference between the estimated latent state vector and the predicted latent state vector. A second Huffman encoder encodes the difference from the second differencer.

Additional features of the present invention will become apparent from the following description and appended claims, taken in conjunction with the accompanying drawings.

### BRIEF DESCRIPTION OF THE DRAWINGS

FIG. 1 is a block diagram of a system communications architecture for a host vehicle and a remote vehicle;

FIG. 2 is a flow chart diagram showing the operation of a processing unit in the architecture shown in FIG. 1;

FIG. 3 is a block diagram showing a process for solving a relative position and velocity vector between vehicles;

FIG. 4 is an illustration of the relative position between vehicles and satellites;

FIG. 5(a) is a diagram of a graph showing a vehicle host node and other vehicle nodes with baselines relative thereto;

FIG. 5(b) shows an optimal-spanning tree including a host node and other vehicle nodes with optimal baselines therebetween;

FIG. 6 is a flow chart diagram showing a process for multi-vehicle precise relative positioning;

FIG. 7 is a block diagram of a system showing compression of GPS measurements;

FIG. 8 is a block diagram showing a system for the decompression of GPS measurements;

FIG. 9 is an overall block diagram of a proposed compression scheme;

FIG. 10 is an illustration of a protocol stack;

FIG. 11 is an example of a frame sequence;

FIG. 12 is a flow chart diagram showing a process for building a Huffman codeword dictionary; and

FIG. 13 is a flowchart diagram of an algorithm for encoding GPS data for transmission.

### DETAILED DESCRIPTION OF THE EMBODIMENTS

The following discussion of the embodiments of the invention directed to a system and method for coding GPS measurements for precise relative positioning in a vehicle satellite communications system is merely exemplary in nature, and is in no way intended to limit the invention or it's applications or uses.

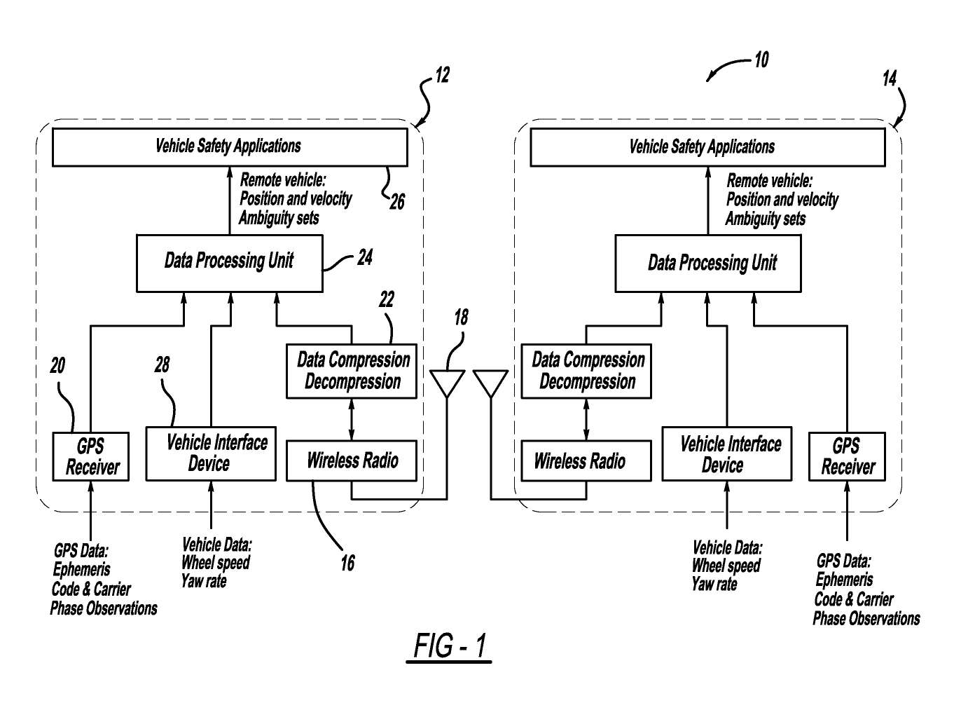

FIG. 1 illustrates a communications architecture 10 for a host vehicle 12 and a remote vehicle 14. The host vehicle 12 and the remote vehicle 14 are each equipped with a wireless radio 16 that includes a transmitter and a receiver (or transceiver) for broadcasting and receiving wireless packets through an antenna 18. Each vehicle includes a GPS receiver 20 that receives satellite ephemeris, code range, carrier phase and Doppler frequency shift observations. Each vehicle also includes a data compression and decompression unit 22 for reducing the communication bandwidth requirement. Each vehicle also includes a data processing unit 24 for constructing a vehicle-to-vehicle (V2V) object map. The constructed V2V object map is used by vehicle safety applications 26. The architecture 10 may further include a vehicle interface device 28 for collecting information including, but not limited to, vehicle speed and yaw rate.

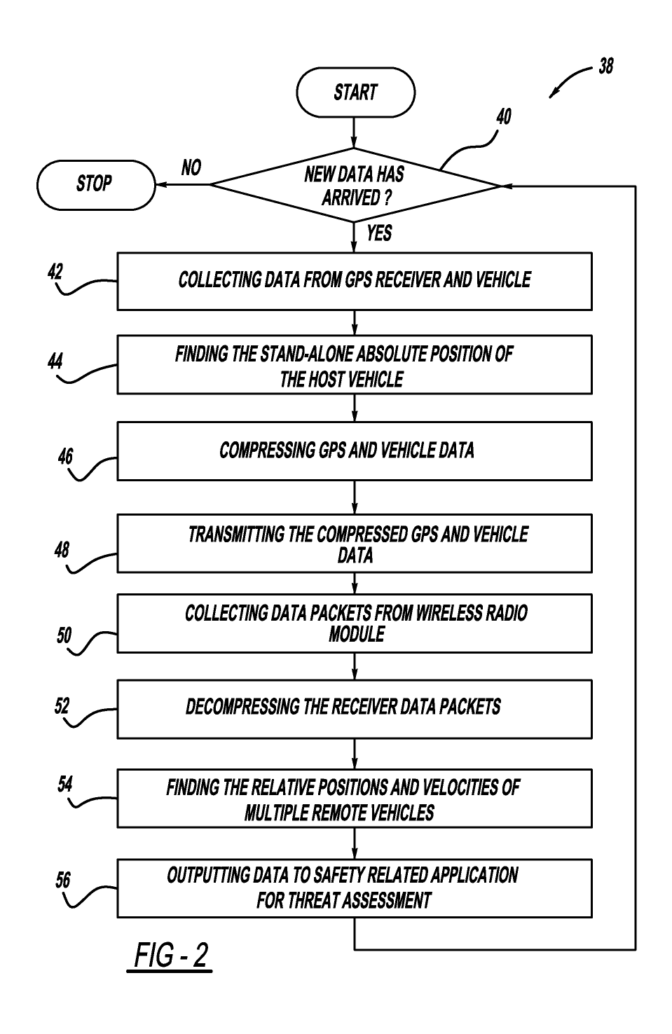

FIG. 2 is a flowchart diagram 38 showing the operation of the processing unit 24 in the architecture 10. The processing unit 24 is triggered once new data is received at decision diamond 40. A first step collects the ephemeris of the satellites, i.e., orbital parameters of the satellites at a specific time, code range (pseudo-range), carrier phase observations, and vehicle data of the host vehicle 12 at box 42. A second step determines the position and velocity of the host vehicle 12 that serve as the moving reference for the later precise relative positioning method at box 44. A third step compresses the GPS and vehicle data at box 46. A fourth step broadcasts the GPS and vehicle data at box 48. A fifth step collects wireless data packets from remote vehicles at box 50. A sixth step decompresses the received data packets and derives the GPS and vehicle data of each remote vehicle at box 52. A seventh step constructs a V2V object map using the precise relative positioning method at box 54. A eighth step outputs the V2V object map to the high-level safety applications for their threat assessment algorithms at box 56.

The data processing unit 24 can be further described as follows. Let X₁,X₂, . . . ,X_{K} be K vehicles. Let Xᵢ be the state of the i-th vehicle, including the position and velocity in Earth-centered and Earth-fixed coordinates (ECEF). Let X_{H} be the state of the host vehicle 12, where 1≦H≦K. Let X be the states of the satellite, including the position and velocity in ECEF coordinates, which can be determined by the ephemeris messages broadcast by the j-th satellite.

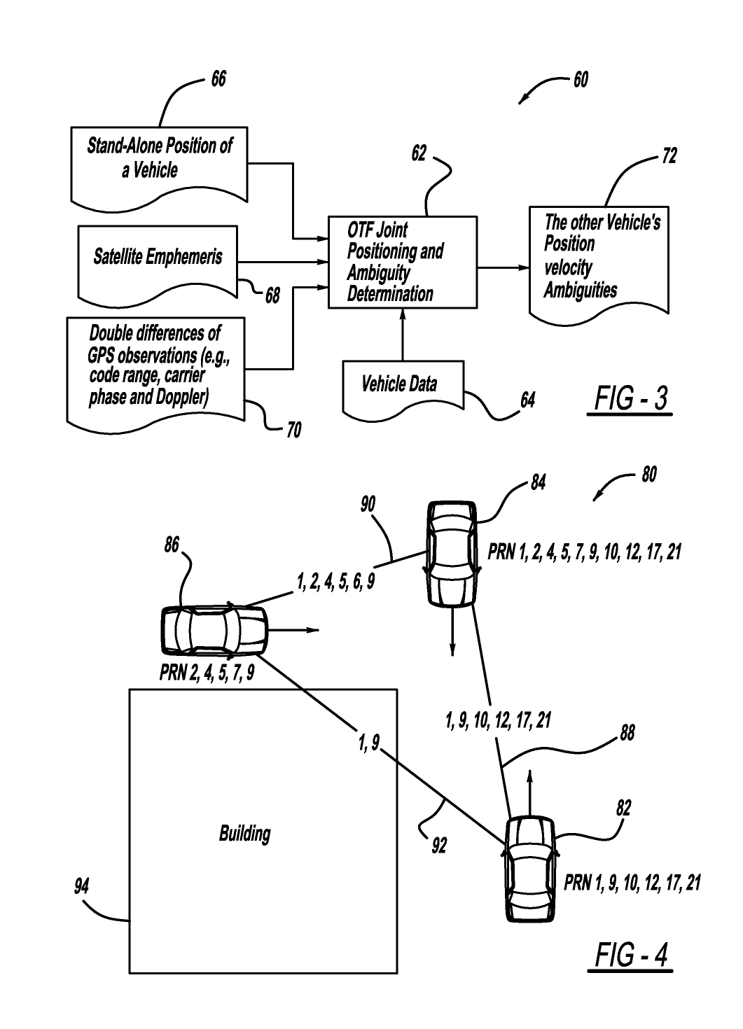

FIG. 3 illustrates a flow chart diagram 60 for precisely solving the relative position and velocity vector between the vehicles. The diagram 60 includes an on-the-fly (OTF) joint positioning and ambiguity determination module 62 that receives information from various sources, including vehicle data at box 64, stand-alone position of a vehicle at box 66, satellite ephemeris at box 68 and double differences of GPS observations at box 70, discussed below. The module 62 outputs the other vehicle's position velocity and ambiguities at box 72. It is noted that the absolute coordinates of one vehicle are required. In a system that only contains moving vehicles, the coordinates of the moving reference are simply estimated using a stand-alone positioning module to supply the approximate coordinates of the reference base coordinates.

Double differential carrier phase measurements for short baselines are used to achieve a high positioning accuracy. Carrier phase measurements are preferred to code measurements because they can be measured to better than 0.01λ, where λ is the wavelength of the carrier signal, which corresponds to millimeter precision and are less affected by multi-path than their code counterparts. However, carrier phase is ambiguous by an integer of the number of cycles that has to be determined during the vehicle operation.

Let the host vehicle Xₕ be the moving reference station. Let bᵢₕ be a baseline between the host vehicle Xₕ and the remote vehicle Xᵢ. The following double-difference measurements of carrier phase, code and Doppler measurements can be written as:

d=H(X_{H},bᵢₕ)bᵢₕ+λN+vᵢₕ (1)

Where H(X_{H},bᵢₕ) is the measurement matrix depending on the moving host vehicle X_{H} and the baseline bᵢₕ, λ is the wavelength of the carrier, N is the vector of the double-difference of ambiguities and vᵢₕ is the unmodelled measurement noise. Without loss of generality, it is assumed that equation (1) is normalized, i.e., the covariance matrix of vᵢₕ is an identity matrix.

The heart of the flow chart diagram 60 is the on-the-fly (OTF) joint positioning and ambiguity determination module 62. In the module 62, a (6+J−1)-dimension state tracking filter is employed to estimate the three position and the three velocity components, as well as J−1 float double-difference of ambiguities as:

d=\tilde{H}(X_{H},bᵢₕ)s+vᵢₕ (2)

Where \tilde{H}(X_{H},bᵢₕ) is the extension of H(X_{H},bᵢₕ) and the joint state s=[bᵢₕ^{N}].

Note that the matrix \tilde{H}(X_{H},bᵢₕ) is not very sensitive to changes in the host vehicle Xₕ and the baseline bᵢₕ. With the process equation of the baseline available, it is usually sufficient to use the host vehicle X_{H} and the predicted estimate \tilde{b}ᵢₕ of the previous time instant. Therefore, when the value d is available, a better estimate of the baseline bᵢₕ can be obtained by the filtering described below.

Let the process equation of the baseline bᵢₕ be:

bᵢₕ(t+1)=ƒ(bᵢₕ(t))+w (3)

Where w denotes un-modeled noise.

In equation (3), ƒ is the function that expresses the dynamical model of the baseline. Some candidates of the dynamical model are a constant velocity model (CV) or a constant turning model (CT). Linearizing equation (3) in the neighborhood of the prediction of the baseline \tilde{b}ᵢₕ of the previous cycle and including the double-difference of ambiguities N gives:

$$s ( t + 1 ) = [ \begin{matrix}I & 0 \\ 0 & F\end{matrix} ] s ( t ) + [ \begin{matrix}0 \\ u\end{matrix} ] + [ \begin{matrix}0 \\ I\end{matrix} ] w \qquad ( 4 )$$

Where I is an identity matrix

$$s ( t + 1 ) = [ \begin{matrix}N \\ {b}_{ih} ( t + 1 )\end{matrix} ] , s ( t ) = [ \begin{matrix}N \\ {b}_{ih} ( t )\end{matrix} ] and u = f ( {\tilde{b}}_{ih} ) - F {\tilde{b}}_{ih} .$$

Now the OTF joint filtering procedure can be written in Algorithm 1, described below.

In equation (1), the measurement matrix H(X_{H},bᵢₕ) plays an important role for the above single baseline positioning method to converge to the correct solution. A geometric dilution of precision (GDOP), i.e., [H(X_{H},bᵢₕ)]⁻¹, affects the quality of the estimate of the baseline bᵢₕ. It can be verified that the GDOP depends on the number of shared satellites and the constellation of the common satellites for the baseline bᵢₕ. For example, when visible shared common satellites between the remote vehicle and the host vehicle are close together in the sky, the geometry is weak and the GDOP value is high. When the visible shared common satellites between the remote vehicle and the host vehicle are far apart, the geometry is strong and the GDOP value is low. Thus, a low GDOP value represents a better baseline accuracy due to the wider angular separation between the satellites. An extreme case is that the GDOP is infinitely large when the number of shared satellites is less than four.

FIG. 4 is a diagram of vehicles 82, 84 and 86, where the vehicle 82 is a host vehicle, used to illustrate the discussion above. A baseline 88 (b_{AB}) is defined between the vehicles 82 and 84, a baseline 90 (b_{BC}) is defined between the vehicles 84 and 86 and a baseline 92 (b_{AC}) is defined between the vehicles 82 and 86. A building 94 is positioned between the vehicles 82 and 86, and operates to block signals of certain satellites so that the vehicles 82 and 86 only receive signals from a few of the same satellites. Particularly, the vehicle 82 receives signals from satellites 1, 9, 10, 12, 17 and 21, the vehicle 84 receives signals from satellites 1, 2, 4, 5, 7, 9, 10,12, 17 and 21 and the vehicle 86 receives signals from the satellites 1, 2, 4, 5, 7, and 9. Thus, the vehicles 84 and 86 receive signals from common satellites 1, 2, 4, 5, 6, and 9 and the vehicles 82 and 84 only receive signals from common satellites 1 and 9. Therefore, the vehicles 82 and 86 do not receive signals from enough common satellites to obtain the relative position and velocity because it takes a minimum of four satellites.

It is noted that there is more than one solution for positioning among multiple vehicles. Consider the scenario shown in FIG. 4 where the host vehicle 82 needs to estimate the relative positions and velocities of the vehicles 84 and 86, i.e., the baselines b_{AB} and b_{AC}, respectively. The baseline b_{AC} can be estimated either directly using the single baseline positioning method or can be derived by combining two other baseline estimates as:

b_{AC}=b_{AB}+b_{BC} (5)

Similarly the baseline b_{AB} has two solutions. It can be verified that the qualities of the two solutions are different. The goal is to find the best solution. As shown in FIG. 4, due to the blockage caused by the building 94, the quality of the estimate of the baseline b_{AC} is degraded because less than four shared satellites (PRN 1, 9) are observed. On the other hand, the baseline b_{AC} inferred from the baselines b_{AB} and b_{AC} is better than the direct estimate of the baseline b_{AC}.

The concept from FIG. 4 can be generalized by introducing a graph G with the vertices denoting the vehicles and edges denoting the baselines between two vertices. Let the weights of the edges be the GDOP of the baseline between two vehicles. The goal is to find a spanning tree, i.e., a selection of edges of G that form a tree spanning for every vertex, with the host vehicle assigned as the root so that the paths from the root to all other vertices have the minimum GDOP.

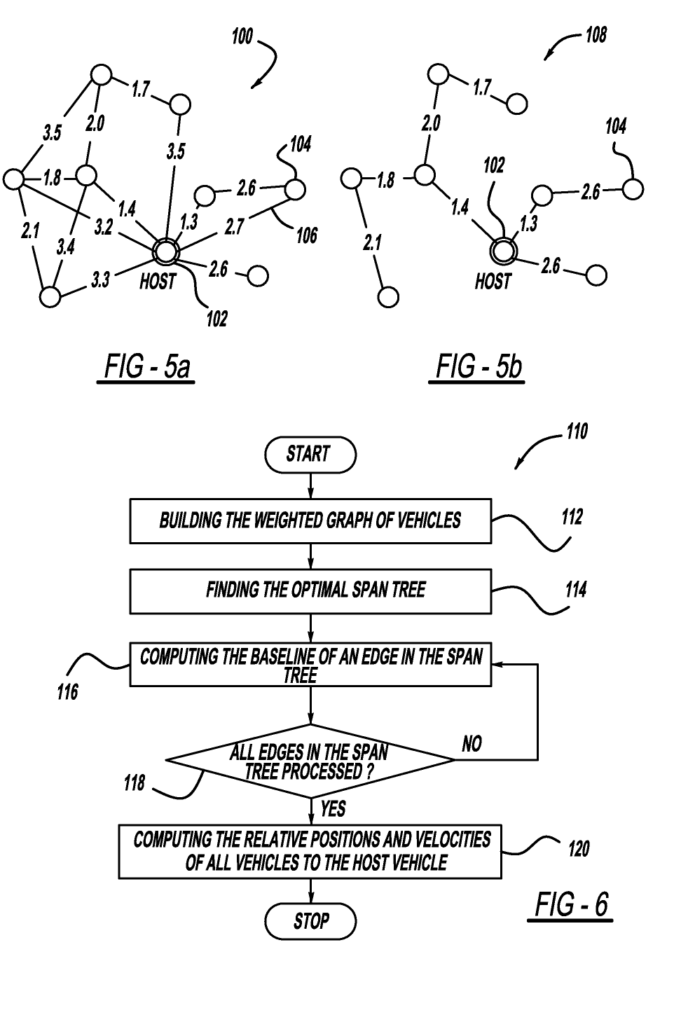

FIG. 5(a) is a diagram of such a weighted graph 100 showing the host vehicle at node 102 and the other vehicles at nodes 104, where an edge or baseline 106 between the host node 102 and the nodes 104 and between the other nodes 104 is giving a weight determined by a suitable GDOP algorithm. FIG. 5(b) shows an optimal-spanning tree 108 with the non-optimal edges or baselines removed.

FIG. 6 is a flow chart diagram 110 showing a process for defining the weighted graph 100 shown in FIG. 5(a) and the optimal-spanning tree 108 shown in FIG. 5(b). The flow chart diagram 110 includes steps of building the weighted graph 100 of nodes at box 112 and then finding the optimal span of the graph 100 at box 114. The algorithm then computes the baseline of an edge in the graph 100 at box 114, and determines whether all of the edges in the span of the graph 100 are processed at decision diamond 118, and if not, returns to the box 116 to compute the next baseline. The algorithm then computes the relative positions and velocities of all of the vehicles relative to the host vehicle at box 120.

The step of computing the baselines to obtain the minimum GDOP in the flow diagram 110 can be performed by any algorithm suitable for the purposes described herein. A first algorithm, referred to as Algorithm 1, is based on a single baseline precision positioning. Given the previous estimate of the joint state ŝ(t−1) with its covariance matrix \hat{P}(t−1); double difference d; GPS time stamp of the receiver t_{R}; satellite ephemeris E; the system dynamical of equation (1); the measurement equation (2); the covariance matrix Q of the noise term w in equation (3); and the covariance matrix R of the noise term v in equation (2).

The updated estimate of the joint state ŝ(t) and the covariance matrix \hat{P}(t) at time t can be solved as follows:
1. Compute the prediction \tilde{s} using equation (1) as:

$$\tilde{s} = [ \begin{matrix}I & 0 \\ 0 & F\end{matrix} ] \hat{s} ( t - 1 ) + [ \begin{matrix}0 \\ u\end{matrix} ]$$

$$and$$

$$\tilde{P} = [ \begin{matrix}I & 0 \\ 0 & F\end{matrix} ] {\hat{P} ( t - 1 ) [ \begin{matrix}I & 0 \\ 0 & F\end{matrix} ]}^{T} + [ \begin{matrix}0 \\ I\end{matrix} ] {Q [ \begin{matrix}0 \\ I\end{matrix} ]}^{T}$$

2. Compute the innovation error as:

e=d−\tilde{H}(\tilde{s})
With \tilde{H}=\tilde{H}(Xₕ,bᵢₕ)
3. Compute innovation covariance S=\tilde{H}\tilde{P}\tilde{H}^{T}+R.
4. Compute Kalman gain as K=\tilde{P}\tilde{H}^{T}S⁻¹.
5. Output the updated estimate ŝ=\tilde{s}+Ke and the covariance matrix \hat{P}=(I−K\tilde{H})\tilde{P}.

The precise relative positioning for multiple vehicles can also be determined by the following algorithm, referred to as Algorithm 2.
1. Build a weighted graph G of vehicles where each vehicle is a vertex and adding an edge between two vertices if the number of shared observed satellites is larger or equal to four. Let the root denote the host vehicle.
2. The weight of an edge is equal to the geometric dilution of precision (GDOP) of the common satellites observed by the two vehicles, i.e., det [H(Xᵢ,bᵢₖ)]⁻¹ in equation (1) for the weight of the edge between the vertices i and j.
3. Use dynamic programming (either revised Bellman-Ford algorithm of Algorithm 3 or Dijkstra algorithm of Algorithm 4) to find a spanning tree such that the path from any other nodes has the best satellite geometry (minimum GDOP) for positioning.
4. For all E in the graph G do
5. Determine the baseline as represented by the edge E by the algorithms described in Algorithm 1.
6. end for
7. Compute relative positions and velocities from the vehicles to the host vehicle based on the graph G.
Algorithm 3 is a reversed Bellman-Ford Algorithm:

Given the graph G with the vertices V={vᵢ|1≦i≦|V|}, the edges E={eₖ|1≦k≦|E|} and the weights of edges {wₖ|1≦k≦|E|}; and the source of vertex H.

Ensure: The span tree T and G:
1. for all vertex v in the set of vertices do
2. if v is the source then
3. Let the cost (v) be 0.
4. else
5. let the cost(v) be ∞.
6. end if
7. Let predecessor(v) be null.
8. end for
9. for i from 1 to |V|−1 do
10. for each edge eₖ in E do
11. Let u be the source vertex of e. Let v be the destination vertex of eₖ.
12. if cost(v) is less than max(wₖ, cost(u)), then
13. Let cost(v)=max(wₖ,cost(u)).
14. Let predecessor(v)=u.
15. end if
16. end for
17. end for
18. Construct the span tree T using the predecessor(v) for all vertices.
Algorithm 4 is a revised Dijkstra algorithm:

Given the graph G with the vertices V={vᵢ|1≦i≦|V|}, the edges E={eₖ|1≦k≦|E|} and the weights of edges {wₖ|1≦k≦|E|}; and the source of vertex H.

Ensure: The span tree T and G:
1. for all vertex v in the set of vertices do
2. if v is the source H then
3. Let the cost (v) be 0.
4. else
5. let the cost(v) be ∞.
6. end if
7. Let predecessor(v) be null.
8. end for
9. Let the set Q contain all vertices in V.
10. for Q is not empty do
11. Let u be vertex in Q with smallest cost. Remove u from Q.
12. if for each neighbor v of u do
13. Let e be the edge between u and v. Let alt=max(cost(u), weight(e)).
14. if alt<cost(v) then
15. cost(v)=alt
16. Let predecessor(v) be u.
17. end if
18. end for
19. end for
20. Construct the span tree T using the predecessor(v) for all vertices.

GPS measurements are correlated through the latent vector of the position and velocity of a GPS receiver, which can be expressed as follows.

Let X be a six-dimension latent state vector consisting of the positions and velocities in ECEF coordinates. Let C be a satellite constellation including the positions and velocities of the satellites in ECEF coordinates, which can be determined by the ephemeris messages broadcasted by the satellites. Let a GPS measured quantity 0 include the code range, carrier phase and Doppler shift for the receiver from the satellites. As a result, the measurement equation can be written as:

O=h(X,β,\dot{β},C)+v (6)

Where β is the host receiver clock error, \dot{β} is the change rate of β and v is the un-modeled noise for GPS measurements including biases caused by ionospheric and tropospheric refractions, satellite orbital errors, satellite clock drift, multipath, etc.

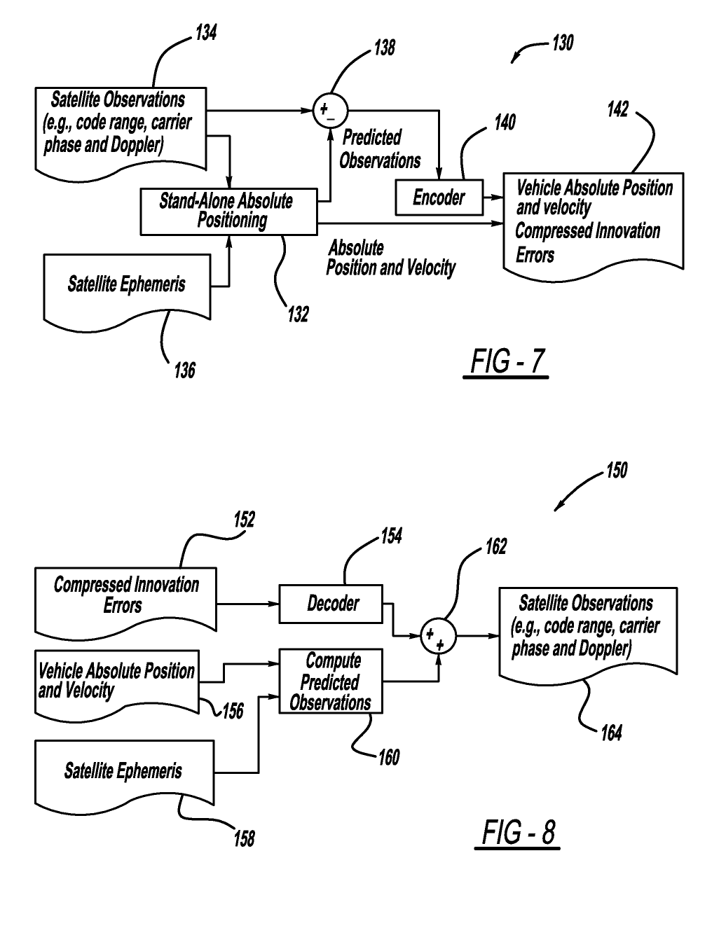

FIG. 7 is a block diagram of a system 130 including a stand-alone absolute positioning module 132 receiving satellite observations at box 134 and satellite ephemeris at box 136. Prediction observations from the positioning module 132 and the satellite observations are provided to an adder 138 where the difference between the signals is encoded by an encoder 140. The encoded signals from the encoder 140 and the absolute positioning velocity signals from the positioning unit 132 are provided as vehicle absolute positioning and velocity signals and compressed innovation errors at box 142.

The stand-alone absolute positioning module 132 monitors the input of measurements including code range, carrier phase and Doppler shift, input of satellite constellation C, and vehicle data (e.g., wheel speed and yaw rate). The module 132 generates the absolute position and velocity of the GPS receiver \hat{X}. The module 132 also generates the predicted GPS measurements Õ as expressed by a function h as:

Õ=h(\hat{X},C) (7)

Therefore, the innovation error e can be defined as:

e=O−Õ (8)

It can be verified that the innovation error vector has two properties. The components are mutually uncorrelated and for each component, the variance is much less than the counterpart of the GPS measurements O. Thus, standard data compression methods, such as, but not limited to, vector quantization or Huffman coding, can be applied to the innovation error e and achieves good compression performance.

FIG. 8 is a block diagram 150 illustrating the inversion operation of the compression module and shows the steps of how to recover the GPS measurements from the received compressed data from a wireless radio module. Particularly, compressed innovation errors at box 152 are provided to a decoder 154 and vehicle absolute position and velocity signals at box 156 and satellite ephemeris signals at box 158 are provided to a compute predicted observations module 160. The signals from the decoder 154 and the observations module 160 are added by an adder 162 to provide satellite observations, such as code range, carrier phase and Doppler frequencies at box 164.

Let the estimate of the absolute position and velocity of the GPS receiver be \hat{X}. The compressed innovation errors is decoded to obtain the corresponding innovation error e. One can verify that the predicted measurements Õ can be computed from the estimate of the absolute position and velocity of the GPS receiver \hat{X} and the satellite constellation C as:

Õ=h(\hat{X},C) (9)

Thus, the recovered GPS measurements can be computed as:

O=Õ+e (10)

The GPS measurements are highly correlated with time. This makes them well suited to compression using a prediction model of the latent state vector X. Let the process equation of the latent state at time instant t be:

X(t+1)=ƒ(X(t))+w (11)

Where ƒ is the system process function of the host vehicle (e.g., constant velocity model, or constant turning model) where the GPS receiver is mounted on the roof of the vehicle and w is the un-modeled noise in the process equation.

The residuals w in equation (11) are well suited to compression by encoding the difference between the current state vector and the predicted state vector from the previous time instant.

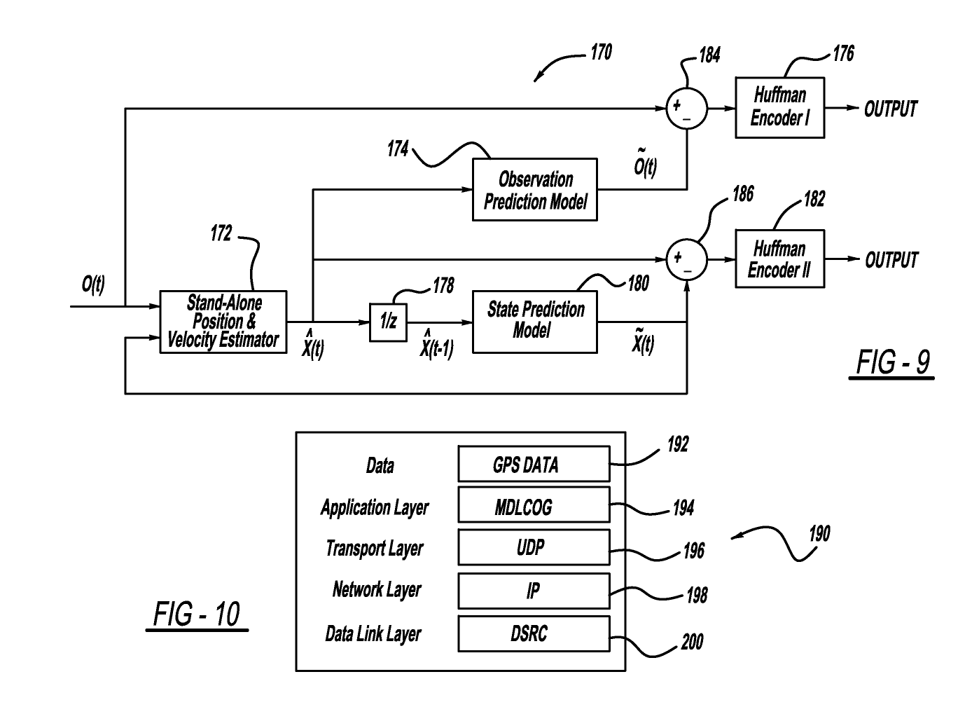

FIG. 9 is a system 170 for a proposed compression scheme. A stand-alone position and velocity estimator 172 monitors the input of GPS measurements O(t) at time instant t and the prediction of the latent state vector \tilde{X}(t) from the previous time t−1, and generates the new estimate of the latent state vector \hat{X}(t). An observation prediction model module 174 calculates the observation prediction Õ(t) using equation (6). A Huffman encoder I module 176 encodes the difference between the input O(t) and the model prediction Õ(t) from an adder 184 using variable-length coding based on a derived Huffman tree. A unit delay module 178 stores the previous latent state vector \hat{X}(t−1). A state prediction model 180 calculates the prediction of the latent state Õ(t). A Huffman encoder II module 182 encodes the difference between the latent state vector \hat{X}(t) and the model prediction \tilde{X}(t) from an adder 186 using variable-length coding based on a Huffman tree.

The minimum description length compression of the GPS protocol (MDLCOG) is designed as an application layer provided above a transport layer, as shown in FIG. 10. Particularly, the MDLCOG is an application layer 194 in a protocol stack 190 positioned between a GPS data layer 192 and a transport layer 196. A network layer 198 is below the transport layer 196 and a data link layer 200 is at the bottom of the protocol stack 190.

The MDLCOG consists of a collection of messages, known as frames, used for initializing and transmission of measurements and additional data, such as GPS time stamp and a bitmap of the observed satellites. These data frames are known as an initialization frame (I-frame), an additional data frame (A-frame), a differential frame (D-frame) and a measurement frame (M-frame).

At the beginning of the data transmission, the encoder sends an I-frame to initialize the state prediction module at the decoder. The I-frame is analogous to the key frames used in video MPEG standards. The I-frame contains the absolute position and velocity of the GPS receiver in ECEF coordinates estimated by the encoder. The I-frame is also sent whenever the difference between the current and previous estimates of the latent state vector X is larger than a threshold.

The A-frame contains the non-measurement data, such as the satellite list, data quality indicators, etc. The A-frame is transmitted only at start-up and when the content changes.

The most frequently transmitted frames are the D-frame and the M-frame. D-frames are analogous to the P-picture frames used in MPEG video coding standards in the sense that they are coded with reference to previously coded samples. The time series difference in the D-frame use the vehicle dynamical model expressed in equation (11). Each D-frame contains the Huffman coded difference between the current and previous estimates of the latent state X. The M-frame contains the GPS time stamp and the Huffman coded difference between the measurements O and the predicted values Õ. The M-frame is sent whenever a new GPS measurement is received, and separate frames are transmitted for L1 and L2 frequencies for the M-frame.

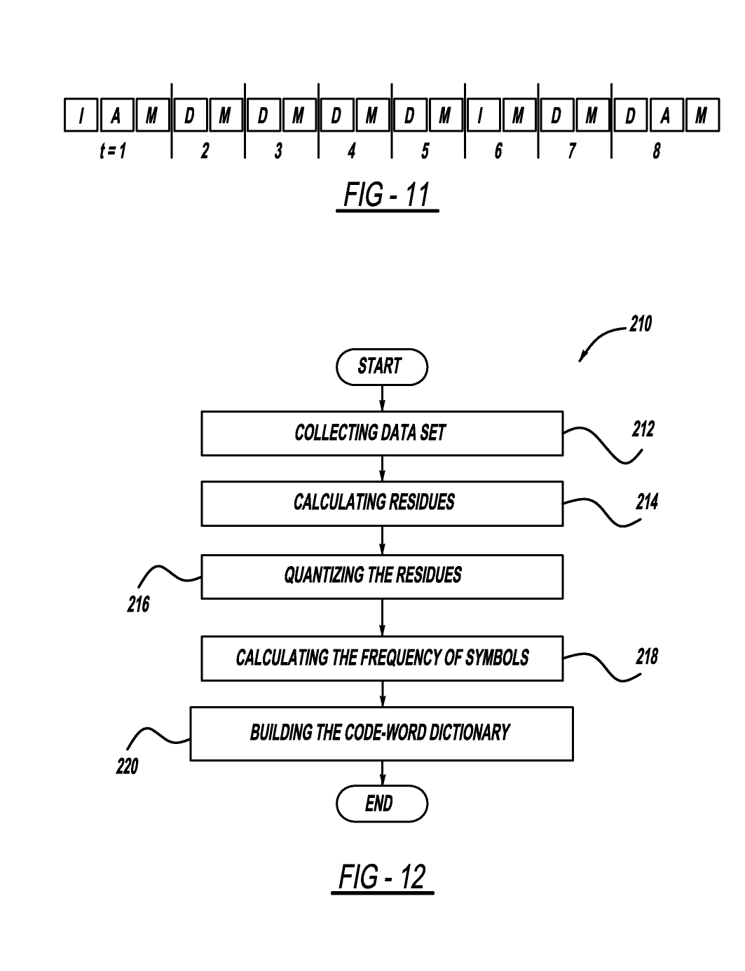

Once the decoder has been initialized, having received the appropriate I-frames and A-frames, the encoder transmits the quantized prediction residual for each epoch in the corresponding D-frame and M-frame. An example of the sequence of frames is shown in FIG. 11. M-frames are sent in each time epoch. At time epoch 1, an I-frame and an A-frame are sent to initialize the prediction modules in the decoder. An I-frame is sent again in epoch 6 because the significant change in the latent state X estimate is detected. An A-frame is transmitted in epoch 8 since a satellite shows up at the horizon or a satellite sets down.

FIG. 12 is a flow chart diagram 210 that outlines the procedure for building a dictionary for coding the residuals. Extensive data of dual frequency GPS data is collected at box 212. At box 214, the ensemble of measurement residuals e or state prediction residuals w is calculated. At box 216, a specific resolution to quantize the residuals is chosen (e.g., 0.2 meter for pseudo-range as the RTCM protocol) and derives a list of symbols. At box 218, the frequency of each symbol in the ensemble is calculated. At box 220, A={a₁,a₂, . . . ,aₙ} is set, which is the symbol alphabet of size n. Then, P={p₁,p₂, . . . ,pₙ} is set, which is the set of the (positive) symbol frequency, i.e., pᵢ=frequency (aᵢ), 1≦i≦n. A code C (A, P)={c₁,c₂, . . . ,cₙ} is generated by building a Huffman tree, which is the set of (binary) code words, where cᵢ is the codeword for aᵢ, 1≦i≦n.

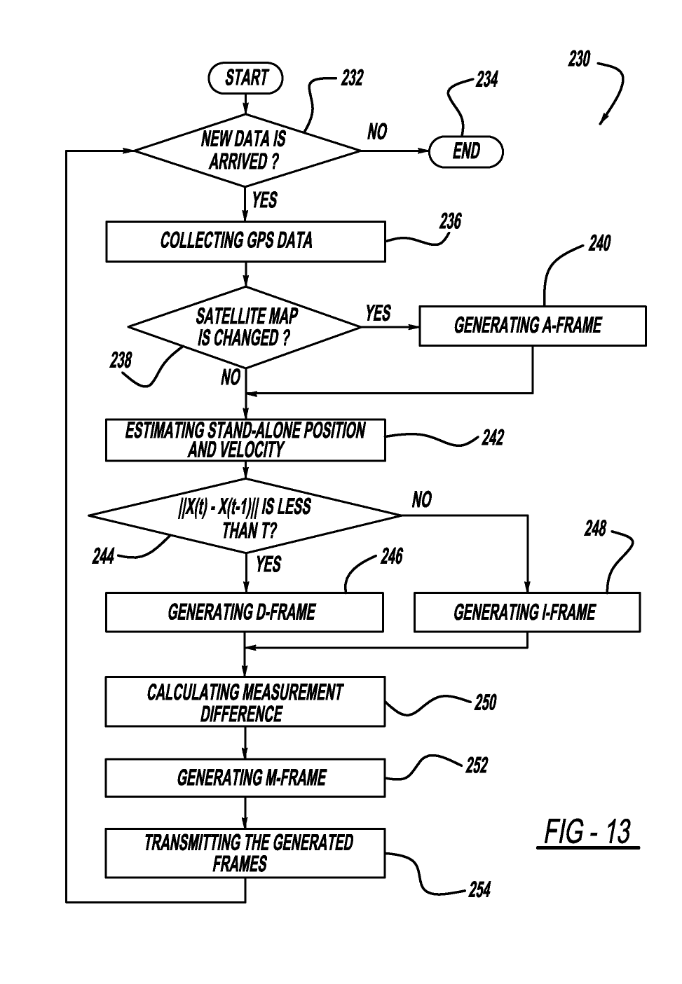

FIG. 13 is a flowchart diagram 230 of an algorithm for encoding GPS data. The procedure starts once new data from the GPS device is received at decision diamond 232, and ends if no data is received at box 234. Then, the GPS data O is collected at box 236 that consists of pseudo-range Rⱼ, Doppler shift Dⱼ and carrier phase Φⱼ from the j-th satellite Xⱼ that belongs to the set C={Xⱼ|1≦j≦J}, with J being the number of visible satellites. The value Xⱼ consists of the three-dimensional position of the j-th satellite in the ECEF coordinates.

The algorithm then determines if the satellite map has changed at decision diamond 238, and if so, the algorithm generates an A-frame at box 240. Particularly, if the identities, i.e., PRN, of the satellite constellation C are changed from the previous time instant, an A-frame is generated to encode the list of the observed satellite's PRN. The frame consists of a 32-bit map, where each bit is either true or false depending on the presence data for a particular satellite.

The algorithm then estimates the stand-alone position and velocity of the vehicle at box 242. In the estimating stand-alone position and velocity module, a Kalman filter is used to estimate the latent state vector X through a series of measurements O. Let the latent state vector X=(x,y,z,\dot{x},\dot{y},ż,β,\dot{β}) denote the concatenated vector of a three-dimensional position vector in the ECEF coordinates, three-dimensional velocity vector in the ECEF coordinates, receiver clock error, and change rate of the receiver clock error, respectively. The linearized system of equation (6) at the neighborhood of X* can be written as:

X(t+1)=FX(t)+u₁+w (12)

Where F is the Jacobian matrix with respect to the latent state vector X and the nonlinear term u₁=ƒ(X*)−FX*.

The measurements of equation (6) of the j-th satellite can be expanded into:

$${R}_{j} = {ρ}_{j} + c β + {v}_{R} \\ λ {Φ}_{j} = {ρ}_{j} + c β + λ {N}_{j} + {v}_{Φ} \\ - \frac{{cD}_{j}}{f} = {\dot{ρ}}_{j} + \frac{{x}_{j} - x}{{ρ}_{j}} \dot{x} + \frac{{y}_{j} - y}{{ρ}_{j}} \dot{y} + \frac{{z}_{j} - z}{{ρ}_{j}} \dot{z} + c \dot{β} + {v}_{D} \qquad ( 13 )$$

For j=1, . . . ,J, where ρ^{j} is the geometrical range between the receiver and the j-th satellite \dot{ρ}^{j} is the projection of the velocity vector of the j-th satellite projected onto the direction of from the receiver to the satellite, c denotes the speed of light, λ and ƒ are the wavelength and frequency of the carrier signal, respectively, v_{R},v_{φ} and v_{D} are the un-modeled measurement noise for pseudo-range, carrier phase and Doppler shift, respectively, and xⱼ,yⱼ and zⱼ are the three-dimensional position of the j-th satellite in the ECEF coordinates.

Note that the quantities ρ^{j} and \dot{ρ}^{j} depend on the vector of the latent state vector X. In other words, equation (13) includes nonlinear equations in terms of the latent state vector X. These quantities are not very sensitive to changes in the latent state vector X. With the receiver's dynamic available, it is usually sufficient to use the predicted estimate \tilde{X} of previous time instant as the center of the linearized neighborhood X* and use it to replace the latent state vector X in equation (13). Therefore, when Rⱼ,Φⱼ and Dⱼ are available, a better estimate of the latent state vector X can be obtained by the filtering method described in Algorithm 5 detailed below.

Equation (13) can be linearized in the neighborhood of X* as:

Oⱼ=HⱼX+u₂_{ⱼ}+vⱼ (14)

Where Oⱼ=[Rⱼ,Φⱼ,Dⱼ]^{T}, Hⱼ is the Jacobian of equation (13) matrix with respect to the latent state vector X and the nonlinear term u₂_{ⱼ}=h(X*)−HⱼX*. Therefore, the key steps of the estimating stand-alone position and velocity module can be outlined in Algorithm 5.

The algorithm then determines whether the current state estimate X(t) and the previous state estimate X(t−1) is larger than a threshold T at decision diamond 244. If the difference between the current state estimate X(t) and the previous state estimate X(t−1) is larger than the threshold T, an I-frame is generated at box 248. The I-frame encodes the current state estimate X(t), including the ECEF position and velocity of the receiver. Otherwise a D-frame is generated to encode the difference X(t)−X(t−1) using Huffman codeword dictionary at box 246.

The next step is to calculate the model residuals at box 250 for the measurements as:

e=O−h(X) (15)

Then, the measurement model residuals are encoded using the Huffman codeword dictionary by generating the M-frame at box 252. In the last step at box 254, all generated frames are transmitted to the lower UDP layer 196.

### Algorithm 5, Absolute Positioning Update

Given the previous estimate of the latent state \hat{X}(t−1) with its covariance matrix \hat{P}(t−1); measurements O(t); GPS time stamp of the receiver t_{R}; satellite ephemerides E; the system dynamical equation (4); measurement equation (6); covariance matrix Q of the noise term w in equation (4); covariance matrix R of the noise term v in equation (6).

The updated estimate of the absolute position and velocity of the receiver \hat{X}(t) at time t.
1. Compute the prediction \tilde{X}=ƒ(\hat{X}(t−1)) and \tilde{P}=F\tilde{P}(t−1)F^{T}+Q.
2. for all j, 1≦j<J do
3. Retrieve the satellite ephemeris of the j-th satellite.
4. Compute the ECEF position Xⱼ=[xⱼ,yⱼ,zⱼ]^{T} and velocity \dot{X}ⱼ=[\dot{x}ⱼ,\dot{y}ⱼ,żⱼ]^{T} of the j-th satellite.
5. Compute ρⱼ=\sqrt{(xⱼ−\tilde{x})²+(yⱼ−\tilde{y})²+(zⱼ−\tilde{z})²} and \dot{ρ}ⱼ=\dot{X}ⱼ^{T}(Xⱼ−\tilde{X}) with \tilde{X}=[\tilde{x},\tilde{y},\tilde{z}]^{T} being the prediction of ECEF position of the receiver.
6. Compute Hⱼ using equation (7):

$${H}_{j} = [ \begin{matrix}- \frac{{x}_{j} - \tilde{x}}{{ρ}_{j}} & - \frac{{y}_{j} - \tilde{y}}{{ρ}_{j}} & - \frac{{z}_{j} - \tilde{z}}{{ρ}_{j}} & 0 & 0 & 0 & c & 0 \\ - \frac{{x}_{j} - \tilde{x}}{{ρ}_{j}} & - \frac{{y}_{j} - \tilde{y}}{{ρ}_{j}} & - \frac{{z}_{j} - \tilde{z}}{{ρ}_{j}} & 0 & 0 & 0 & c & 0 \\ 0 & 0 & 0 & \frac{{x}_{j} - \tilde{x}}{{ρ}_{j}} & \frac{{y}_{j} - \tilde{y}}{{ρ}_{j}} & \frac{{z}_{j} - \tilde{z}}{{ρ}_{j}} & 0 & c\end{matrix} ]$$

7. end for
8. Compute H=[H₁^{T}, . . . ,H_{J}^{T}]^{T}.
9. Compute innovation error using equation (5), i.e.,

e=O(t)−h(\tilde{X})
10. Compute innovation covariance S=H\tilde{P}H^{T}+R.
11. Compute Kalman gain K=\tilde{P}H^{T}S⁻¹.
12. Output the updated estimate \hat{X}=\hat{X}+Ke and the covariance matrix \hat{P}=(I−KH)\tilde{P}.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for coding GPS measurements in a vehicle communications system, said system comprising:
a stand-alone position and velocity estimator receiving GPS measurement information at a first time and a prediction of a latent state vector from a previous time, said position and velocity estimator generating an estimated latent state vector;
an observation prediction model responsive to the estimated latent state vector from the position and velocity estimator and calculating an observation prediction from the estimated latent state vector;
a first differencer responsive to the observation prediction from the observation prediction model and the GPS measurement information at the first time period and providing a first difference signal;
a first encoder responsive to the first difference signal and providing a first coded output;
a state prediction model responsive to the estimated latent state vector from the position and velocity estimator and outputting the predicted latent state vector;
a second differencer responsive to the estimated latent state vector from the position and velocity estimator and the predicted latent state vector from the state prediction model and generating a second difference signal; and
a second encoder responsive to the second difference signal and generating a second coded output.

2. The system according to claim 1 wherein the GPS measurement information is part of an application layer in a protocol stack.

3. The system according to claim 2 wherein the GPS measurement information includes a series of data frames including an initialization frame, an additional data frame, a differential frame and a measurement frame.

4. The system according to claim 1 wherein the stand-alone position and velocity estimator provides the latent state vector that includes six-dimensions of the position and velocity in earth-center/earth-fixed coordinates of satellites.

5. The system according to claim 1 wherein the GPS measurement information includes satellite ephemeris, code range, carrier phase and Doppler shift for satellites.

6. The system according to claim 1 wherein the stand-alone position and velocity estimator includes a Kalman filter for estimating the latent state vector.

7. The system according to claim 1 wherein the first and second encoders provide the first and second coded outputs with M-frames of data.

8. The system according to claim 1 wherein the first and second differencers provide model residuals.

9. The system according to claim 1 wherein the first and second encoders are Huffman encoders.

10. A system for coding GPS measurements in a vehicle communications system, said system comprising:
a stand-alone position and velocity estimator receiving GPS measurement information at a first time and a prediction of a latent state vector from a previous time, said position and velocity estimator generating an estimated latent state vector, wherein the GPS measurement information includes satellite ephemeris, code range, carrier phase and Doppler shift for satellites and includes a series of data frames including an initialization frame, an additional data frame, a differential frame and a measurement frame and wherein the stand-alone position and velocity estimator provides the latent state vector to include six-dimensions of the position and velocity in earth-center/earth-fixed coordinates of satellites;
an observation prediction model responsive to the estimated latent state vector from the position and velocity estimator and calculating an observation prediction from the estimated latent state vector;
a first differencer responsive to the observation prediction from the observation prediction model and the GPS measurement information at the first time period and providing a first difference signal that includes model residuals;
a first Huffman encoder responsive to the first difference signal and providing a first coded output;
a state prediction model responsive to the estimated latent state vector from the position and velocity estimator and outputting the predicted latent state vector;
a second differencer responsive to the estimated latent state vector from the position and velocity estimator and the predicted latent state vector from the state prediction model and generating a second difference signal that includes model residuals; and
a second Huffman encoder responsive to the second difference signal and generating a second coded output.

11. The system according to claim 10 wherein the GPS measurement information is part of an application layer in a protocol stack.

12. The system according to claim 10 wherein the stand-alone position and velocity estimator includes a Kalman filter for estimating the latent state vector.

13. The system according to claim 10 wherein the first and second Huffman encoders provide the first and second coded outputs with M-frames of data.

14. A method for coding GPS measurements in a vehicle communications system, said method comprising:
estimating a latent state vector using GPS measurement information at a first time and a prediction of a latent state vector from a previous time;
calculating an observation prediction from the estimated latent state vector;
providing a first difference signal between the observation prediction and the GPS measurement information at the first time period;
encoding the first difference signal to provide a first coded output;
using a state prediction model to generate the predicted latent state vector using the estimated latent state vector;
providing a second difference signal between the estimated latent state vector and the predicted latent state vector; and
encoding the second difference signal to generate a second coded output.

15. The method according to claim 14 wherein encoding the first and second difference signals includes providing M-frames of data.

16. The method according to claim 14 wherein providing a first and second difference signal include providing model residuals.

17. The method according to claim 14 wherein encoding the first and second difference signals includes using Huffman encoders.

18. The method according to claim 14 wherein estimating a latent state vector includes estimating a latent state vector with six-dimensions of the position and velocity in earth-center/earth-fixed coordinates of satellites.

19. The method according to claim 14 wherein estimating a latent state vector includes using a Kalman filter for estimating the latent state vector.

20. The method according to claim 14 wherein the GPS measurement information includes satellite ephemeris, code range, carrier phase and Doppler shift for satellites.
